(19) United States
(12) Patent Application Publication
(10) Pub. No.: US 2014/0363728 A1
(43) Pub. Date: Dec. 11, 2014

(54) BATTERY PACK

(71) Applicants: Panasonic Corporation, Osaka (JP); SANYO Electric Co., Ltd., Osaka (JP)

(72) Inventors: YUKIO NISHIKAWA, Osaka (JP); TOMOMI TANAKA, Osaka (JP); TAKUYA TSUTSUMI, Hyogo (JP)

(21) Appl. No.: 14/296,469

(22) Filed: Jun. 5, 2014

(30) Foreign Application Priority Data
Jun. 7, 2013 (JP) 2013-120777

(51) Int. Cl. H01M 2/26

(52) U.S. Cl. CPC H01M 2/266
USPC 429/160

(57) ABSTRACT

A battery pack that has superior output characteristics and long-term reliability and is less expensive is provided. More specifically, a battery pack is provided that includes plurality of batters cells each having electrode terminals including a positive terminals and a negative terminal, the battery cells being stacked on top of one another; and a bus bar haying a bent portion, the bus bar being welded and electrically connected to the electrode terminals, wherein each of the electrode terminals is formed of a flat plate, and a stacking direction of the electrode terminals and a stacking direction of the battery cells are the same, and the electrode terminal of one of the battery cells and the electrode terminal of another one of the battery cells are electrically connected by the bus bar.

### CROSS REFERENCE TO RELATED APPLICATIONS

The disclosure of Japanese Patent Application No. 2013-120777 tiled on Jun. 7, 2013 including the specification, drawings and abstract is incorporated herein by reference in its entirety.

### TECHNICAL FIELD

The present invention relates to a battery pack having stacked battery cells.

### BACKGROUND ART

Conventional battery packs come in the form of battery modules having a large number of stacked cartridges each having one to three battery cells mounted therein. At the time of battery module fabrication, each plate-shaped electrode terminal is partially bent, and a plate, a bus bar and other components are then welded to the corresponding surface of the electrode terminal, However, use of a large number of cartridges and the need for a module case increase the overall size of a battery module as well as the complexity of the manufacturing process of the battery module.

To address the above-described problem, battery packs have been proposed that are composed of battery cells fastened together with fastening members inserted through fastening through-holes having specific shape that are formed in the electrodes protruding from the bodies of the battery cells (see, e.g., PTL 1).

FIG. 9 is a schematic view showing a conventional battery pack fastening method disclosed in PTL 1. A battery pack shown in FIG. 9 includes battery cell 100 having electrode terminal 120 and battery cell 101 having electrode terminal 121. Electrode terminals 120 and 121 are electrically connected either in series or in parallel via a conductive connecting member (not shown) which is to be fastened to insulating member 300.

Battery pack are proposed wherein bus bars are welded to the electrode terminals provided on the side surfaces of the respective stacked battery cells so that the respective electrode terminals are fastened together (see, e.g., PTLs 2 and 3).

### CITATION LIST

### Patent Literature

PTL 1

Japanese Patent No. 4757879

PTL 2

Japanese Patent Application Laid-Open No 2011-138765

PTL 3

Japanese Translation of a PCT Application Laid-Open No. 2011-515010

### SUMMARY OF INVENTION

### Technical Problem

In the battery pad according to PTL 1 with the configuration shown in FIG. 9, the battery cells are fastened together mainly by screw 400. Thus, contact resistance occurs at a joint between screw 400 and each electrode terminal, resulting in increased electric resistance and thus low output characteristics due to electric loss. The battery pack suffers from the drawbacks of not only being likely to reduce the long-term reliability of the fastening force due to screw loosening and/or crevice corrosion, but also requiring higher manufacturing costs due to a greater number of parts including screws.

In the battery packs according to PTLs 2 and 3, the electrode terminals are provided on the side surfaces of the respective stacked battery cells, and the respective battery cells are coupled together by bus bars. As a result, a shearing force acts on the connected portions between the battery cells and the electrode terminals due to compression pressure in the stacking direction of the battery cells. The battery packs according to PTLs 2 and 3 thus have the drawback of being likely to reduce the long-term reliability of the connected portions.

The present invention solves the aforementioned problems pertinent in the art, and an object of the present invention is to provide a battery pack having low electric resistance and superior long-term reliability with low manufacturing costs

### Solution to Problem

In order to attain the above described object, the present invention provides a battery pack that includes a plurality of battery cells each having electrode terminals including a positive terminal and a negative terminal, the battery cells being stacked on top of one another, and a bus bar that has a bent portion and is welded and electrically connected to the electrode terminals. Each of the electrode terminals is formed of a flat plate, and a stacking direction of the electrode terminals and a stacking direction of the battery cells are the same. The electrode terminal of one of the battery cells and the electrode terminal of another one of the battery cells are electrically connected by the bus bar.

### Advantageous Effects of Invention

The present configuration can provide a battery pack that does not require an exterior component such as a cartridge. Since the electrode terminals (including a positive terminal and a negative terminal) and the bus bar are welded together (metal joining), the electric resistance is small. Accordingly, the battery pack exhibits improved output characteristics. The battery pack of the present invention does not require fastening of battery cells by screws or other fastening means. Accordingly, a possible reduction in the coupling force due to looseness of screws or the like does not occur, and thus long-term reliability can be ensured. Each of the electrode terminals is formed of a flat plate, and the stacking direction of the electrode terminals and the stacking directions of the battery cells are the same. As a result, a shearing force can be prevented from acting on the connected portion between the battery cell body and the electrode terminal due to compression pressure in the stacking direction of the battery cells, and long-term reliability of the connected portions can be ensured. In addition, the manufacturing costs can be reduced.

As described above, the present invention can provide an inexpensive battery pack superior in output characteristics and long-term reliability.

### BRIEF DESCRIPTION OF DRAWINGS

FIG. 1A is a schematic configuration view of series joining in a battery pack according to Embodiment 1;

FIG. 1B is a schematic configuration view of the series joining in the battery pack according to Embodiment 1;

FIG. 1C is a schematic configuration view of the series joining in the battery pack according to Embodiment 1;

FIG. 2 is a schematic configuration view showing how butt welding is performed in the battery pack according to Embodiment 1;

FIG. 3A is an enlarged view of a butt-welded portion of the battery pack according to Embodiment 1;

FIG. 3B is an enlarged view of the butt-welded portion of the battery pack according to Embodiment 1;

FIG. 3C is an enlarged view of the butt-welded portion of the battery pack according to Embodiment 1;

FIG. 4 is a schematic configuration view showing how lap welding is performed in a battery pack according to Embodiment 2;

FIG. 5A is an enlarged view of a lap-welded portion of the battery pack according to Embodiment 2;

FIG. 5B is an enlarged view of the lap-welded portion of the battery pack according to Embodiment 2;

FIG. 5C is an enlarged view of the lap-welded portion of the battery pack according to Embodiment 2;

FIG. 6A is a schematic configuration view of parallel joining of a battery pack according to Embodiment 3;

FIG. 6B is a schematic configuration view of the parallel joining of the battery pack according to Embodiment 3;

FIG. 6C is a schematic configuration view of the parallel joining of the battery pack according to Embodiment 3;

FIG. 7 is a schematic configuration view showing how butt welding is performed in the battery pack according to Embodiment 3;

FIG. 8 is a schematic configuration view showing how lap welding is performed in a battery pack according to Embodiment 4; and

FIG. 9 is a schematic view showing, a conventional battery pack coupling method disclosed in PTL 1.

### DESCRIPTION OF EMBODIMENTS

A battery pack according to the present invention includes a plurality of battery cells each having a positive terminal and a negative terminal and are stacked on top of one another, and a bus bar that is welded and electrically connected to the positive terminal and the negative terminal.

Each battery cell included in the battery pack according to the present invention is preferably a secondary battery and has electrode terminals including a positive terminal and a negative terminal. Examples of the secondary battery include a lithium secondary battery, a nickel metal-hydride (Ni—MH) battery, and a nickel-cadmium (Ni—Cd) battery. Lithium secondary batteries are classified into cylindrical batteries, rectangular batteries, pouch-shaped batteries, and the like according to their shape. Among these batteries, rectangular batteries and pouch-shaped batteries which are to be stacked with a high degree of integration are preferred. Light-weight pouch-shaped batteries are particularly preferred.

The electrode terminals (the positive terminal and the negative terminal) of each battery cell are preferably plate-shaped electrode terminals. The positive terminal and the negative terminal may be disposed at any part of the battery cell and preferably protrude from the battery cell. When the battery cells are stacked on top of one another to form a battery pack, the batters cells are preferably disposed such that the positive terminals overlap one another and the negative terminals overlap one another in a stacking direction of the battery cells.

As described above, the battery pack according to the present invention is preferably configured such that the positive terminals overlap one another and the negative terminals overlap one another along the stacking direction of the battery cells. An insulator may be disposed in spaces between two adjacent positive terminals and in spaces between two adjacent negative terminals. The insulator ensures strength enough to withstand compression pressure in the stacking direction of the battery cells. The insulator also limits surface discharge and prevents a short circuit.

Each electrode terminal is formed of a conductive member through which electric current is passed by an electrochemical reaction in the battery pack. Aluminum, copper, nickel, an alloy thereof or the like is preferably used as the material for the conductive member.

The bus bar in the battery pack according to the present invention refers to a conductor that connects together a plurality of electrode terminals to create a bypass. Any bus bar can be employed as long as it is capable of electrically connecting, electrode terminals. Specific examples of the bus bar include a metal plate and a metal wire.

The bus bar has a bent portion and is welded and electrically connected to the electrode terminals in the battery pack. Any welding method can be employed; butt welding, lap welding or any other method may be used. The details of the welding method will be described later.

The bus bar electrically connects electrode terminal “a” of one battery cell A and electrode terminal “b” of another battery cell B in the battery pack. Electrode terminal “a” and electrode terminal “b” may have the same polarity (either positive or negative) or may have different polarities. That is, battery cell A and battery cell B may be connected in parallel or m series via the bus bar.

The battery pack according to the present invention can be provided as a battery module The battery module includes, in addition to the battery pack, a circuit section that controls the operation of the batteries and preferably has a case for housing the circuit section and the battery pack.

The battery pack according to the present invention is used for example in electrical storage apparatus that require high power and large capacity, including electrical products, power-assisted bicycles, electric power tools, automobiles, and home appliances.

Embodiments of the present invention will now be described with reference to the accompanying drawings.

### Embodiment 1

Series Connection and Butt Welding

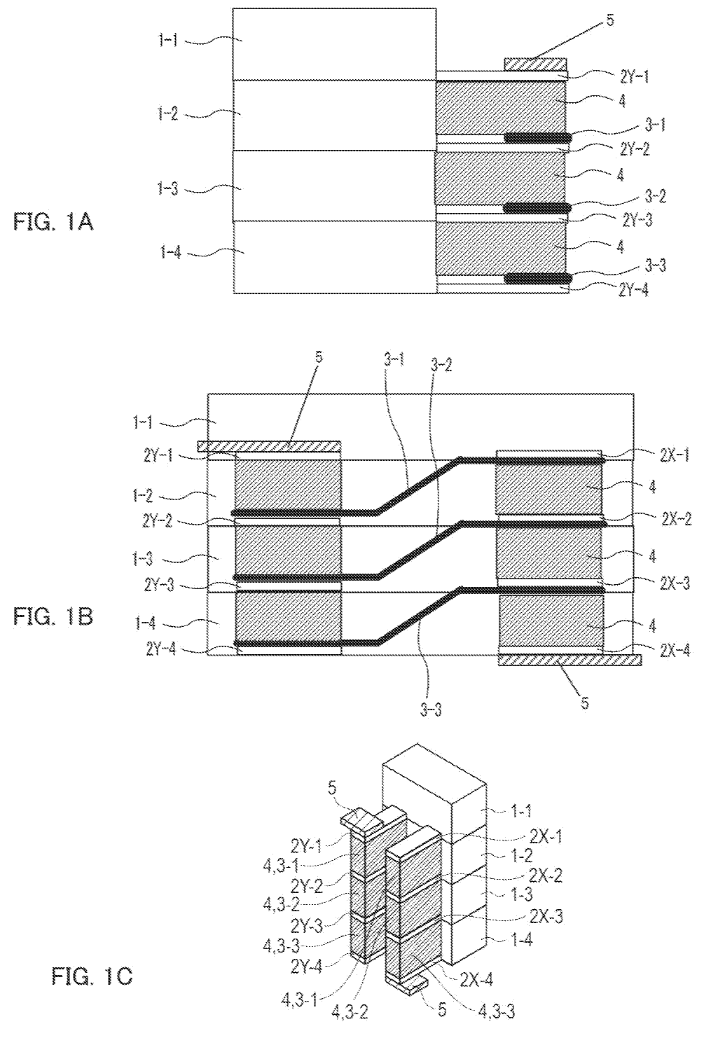

FIGS. 1A to 1C show a schematic configuration of a battery pack according to Embodiment 1. FIG. 1A is a side view of the battery pack, FIG. 1B is a front view of the battery pack, and FIG. 1C is a perspective view of the battery pack. In FIG. 1C, each bus bar 3 and corresponding insulating layer 4 are drawn as one component and are not differentiated from each other.

In the battery pack according to Embodiment 1, battery cells 1 (1-1, 1-2, 1-3, and 1-4) which are pouch-shaped batteries are stacked on top of one another, as shown in FIGS. 1A to 1C. As a matter of course, the number of battery cells 1 stacked is not limited to four and only needs to be two or more.

Electrode terminals 2 (positive terminal 2X and negative terminal 2Y) of each battery cell 1 protrude from one side surface of the battery pack. Positive terminals 2X (2X-1, 2X-2, 2X-3, and 2X-4) overlap one another and negative terminals 2Y (2Y-1, 2Y-2, 2Y-3, and 2Y-4) overlap one another.

Bus bar 3 and insulating layer 4 are provided between two adjacent electrode terminals 2 of stacked battery cells 1. General terminal 5 is a terminal for exchanging electric current with an external apparatus provided outside the battery pack.

As shown in FIG. 1B battery cells 1 (1-1 1-2, 1-3 and 1-4) are electrically connected to one another in series by bus bars 3 (3-1, 3-2, and 3-3). That is, positive terminal 2X-1 of battery cell 1-1 and negative terminal 2Y-2 of battery cell 1-2 are electrically connected by bus bar 3-1; positive terminal 2X-2 of battery cell 1-2 and negative terminal 2Y-3 of battery cell 1-3 by bus bar 3-2; and positive terminal 2X-3 of battery cell 1-3 and negative terminal 2Y-4 of battery cell 1-4 by bus bar 3-3.

The role of insulating layer 4 is to secure strength sufficient to withstand compression in a stacking direction and prevent a short circuit or surface discharge between electrode terminals 2 or between bus bars 3.

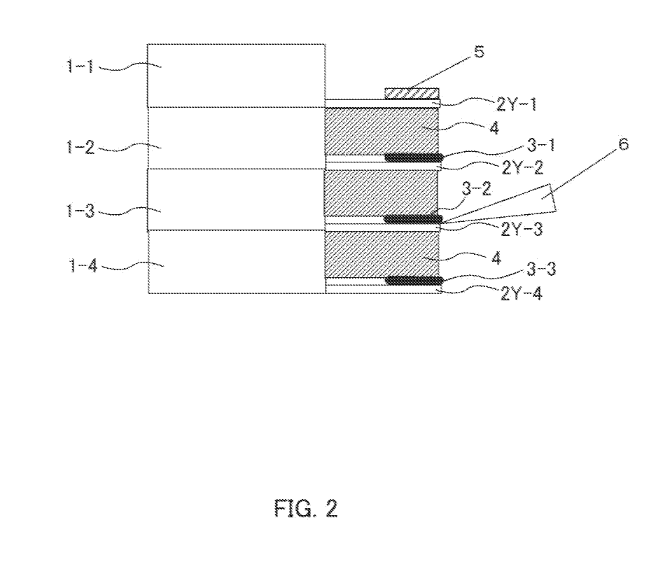

FIG. 2 is a side view of the battery pack and shows a schematic configuration when electrode terminal 2 and bus bar 3 are butt-welded. As shown in FIG. 2, laser beam 6 is moved in a horizontal direction while laser beam 6 is applied to a boundary portion between electrode terminal 2 (e.g., negative terminal 2Y) and bus bar 3. With this operation, bus bar 3 is welded to electrode terminal 2.

The irradiation angle of laser beam 6 may be set such that laser beam 6 is applied in parallel to an interface between electrode terminal 2 and bus bar 3; however, if insulating layer 4 is an obstacle for laser irradiation, laser beam 6 may be inclined with respect to the interface. Also in this case, welding can be performed without problem. Welding can be performed without problem as long as the angle of inclination of laser beam 6 with respect to a direction parallel to the interface is within 20°.

A laser light source of laser beam 6 may be a laser source suitable for metal welding, such as a YAG laser source, a Ether laser source, or a carbon dioxide as laser source. Detailed joining conditions depend on metal materials (e.g., aluminum or copper) used in electrode terminal 2 and bus bar 3. Welding is possible at a rate of 40 mm/sec when the power is 400 W.

Insulating layer 4 may be made of resin material. When laser beam 6 is applied, the resin material that constitutes insulating layer 4 may not excessively be affected by heat (e.g., be carbonized), and a trace of the application is unlikely to remain.

As described above, with the welding method according to Embodiment 1, welding can be performed with the components being stacked on top of one another. This eliminates the need tot an joining member, reduces the number of processes, and lowers manufacturing costs.

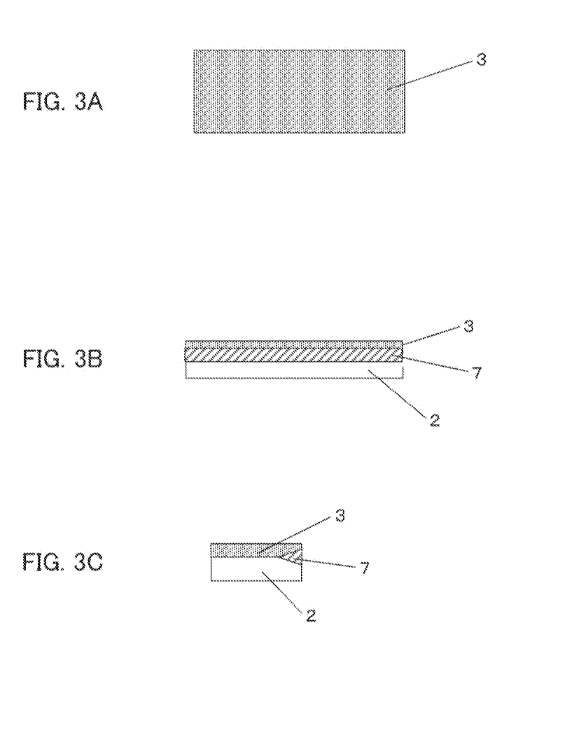

FIGS. 3A to 3C are enlarged views of electrode terminal 2 butt-welded to bus bar 3. FIG. 3A is a top view of electrode terminal 2 as seen from the bus bar 3 side, FIG. 3B is a front view, and FIG. 3C is a cross-sectional side view. As shown in FIG. 3C, welded portion 7 is wedge-shaped when observed in a cross-section. Since the irradiation angle of laser beam 6 is set such that laser beam 6 is parallel to the interface between electrode terminal 2 and bus bar 3, as shown in FIG. 3C, welded portion 7 is formed so as to extend along mating surfaces of electrode terminal 2 and bus bar 3. When laser beam 6 is applied at oblique angle, an inclined welded portion is formed to be lopsided.

When welding is performed under the conditions in FIG. 2, the depth of penetration of welded portion 7, penetrating along the mating surfaces of electrode terminal 2 and bus bar was in a range from 0.3 mm to 0.5 mm. Characteristics required for welded portion 7 are high weld strength, low electric resistance, and less susceptibility to heat.

In welded portion 7 shown in FIGS. 3A to 3C which was obtained by welding under the conditions of FIG. 2, the weld strength per unit weld length measured in a peel test was 20 N/mm. Since the depth of penetration of welded portion 7 described above as in the range from 0.3 mm to 0.5 mm, the stress value corresponding to the above described weld strength is in a range from 40 N/mm² to 67 N/mm².

The material of electrode terminal 2 is an annealed material of oxygen free copper, and a yield stress of the material of electrode terminal 2 has a value of 76 N/mm² to 84 N/mm² inclusive. From the above, in order to ensure the weld strength required for welded portion 7, weld length 1 (unit: mm) of welded portion 7 needs to satisfy the following relationship:

$$\begin{matrix}1 = P \text{/} {σ}_{1} \text{/} a \\ = P \text{/} {σ}_{2} \cdot ( {σ}_{2} \text{/} {σ}_{1} \text{/} a ) \geq \\ P \text{/} {σ}_{2} \times ( 84 \text{/} 40 \text{/} 0.3 ) \\ = P \text{/} {σ}_{2} \times 7\end{matrix}$$

In the expressions, P (unit: N) is the weld strength required for welded portion 7, σ₁ (unit: N:mm²) is the stress corresponding to the above described weld strength, σ₂ (unit: N/mm²) is the yield stress of the electrode material, and a (unit: mm) is the depth of penetration of welded portion 7.

Namely, the weld length (unit: mm) of welded portion 7 may be at least seven times as large as the value obtained by dividing the weld strength (unit: N) which is required for welded portion 7 by the yield stress (unit: N/mm²) of the electrode material.

Electric resistance is dependent on weld length. When the weld length is 10 mm or more the electric resistance of welded portion 7 becomes lower than that of a product fastened with screws. At this time in regard with heat effect, the maximum temperature of the electrode material inside a battery cell side by 3 mm horn the mating surfaces was 100° C. or lower, a value lower than the heat resistant temperature of the components of the battery cell.

Accordingly, when the weld length (unit: mm) of welded portion 7 is at least seven times as large as the numeric value which is obtained by dividing the weld strength (unit: N) required for welded portion 7 by the yield stress (unit: N/mm²) of the electrode material, and the weld length is 10 mm or more, the specifications of the strength, the electric resistance and the heat resistant temperature which are required. for welded portion 7 are satisfied.

Friction stirring or any other welding method may be used as a method for butt welding, instead of a laser-based method

### Embodiment 2

Series Connection and Lap Welding

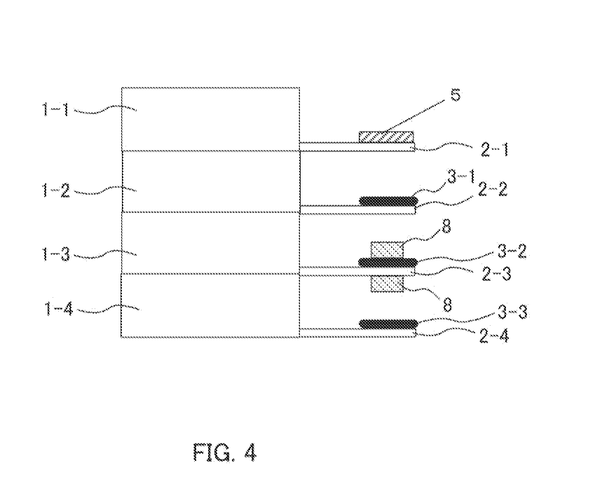

FIG. 4 is a side view of a battery pack showing a schematic configuration of a battery pack according to Embodiment 2. In FIG. 4, the same components as those in FIGS. 1A to 1C and 2 are denoted by the same reference numerals, and a description thereof will be omitted.

In the battery pack according to Embodiment 2, battery cells 1 (1-1, 1-2, 1-3, and 1-4), each having electrode terminals 2 (positive terminal 2X and negative terminal 2Y), are stacked on top of one another, as shown in FIG. 4.

As shown in FIG. 4, electrode terminals 2 (positive terminals 2X and negative terminals 2Y) and bus bars 3 are lap-welded. Although lap welding will be described in the context of ultrasonic welding in Embodiment 2, lap welding may be performed by any other means, such as laser welding, resistance welding, or TIG welding

As shown in FIG. 4, a stack of electrode terminal 2 and bus bar 3 is clamped by ultrasonic welding tool 8 and given vibration while applying pressure. For example, electrode terminal 2 and bus bar 3 are welded for a vibration time of 200 ms under a welding pressure of 40 N.

When insulating layer 4 (not shown in FIG. 4, see FIGS. 1A to 1C) is inserted after the lap welding, bus bar 3 and insulating layer 4 are disposed between two adjacent electrode terminals 2, as in FIGS. 1A to 1C.

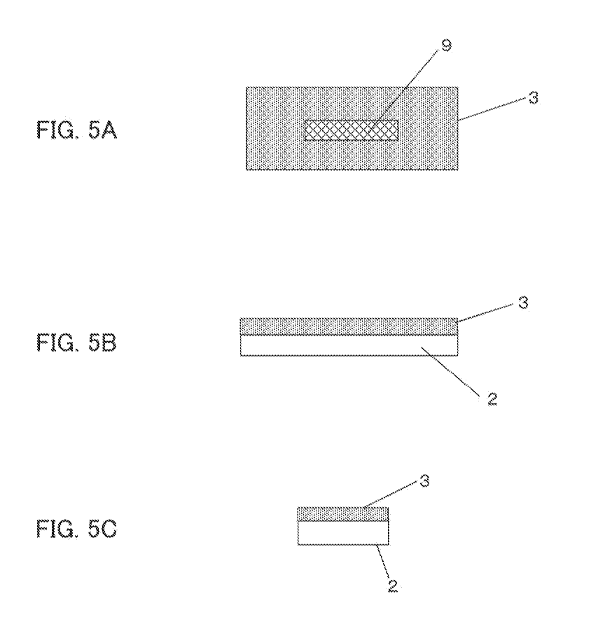

FIGS. 5A to 5C are enlarged views of a welded portion of electrode terminal 2 lap-welded to bus bar 3. FIG. 5A is a top view of electrode terminal 2 as seen from the bus bar 3 side, FIG. 5B is a front view, and FIG. 5C is a cross-sectional side view. As shown in FIG. 5A, when ultrasonic welding is performed with ultrasonic welding tool 8 aligned with the center of bus bar 3, mark 9 of ultrasonic welding tool 8 remains at a surface of bus bar 3. Although a top view from the electrode terminal 2 side is not shown, a tool mark also remains on the electrode terminal 2 side.

As shown in the side view in FIG. 5B and the cross-sectional view in FIG. 5C, electrode terminal 2 and bus bar 3 are joined at their interface, Unlike Embodiment 1, a welded portion (see FIGS. 3A to 3C) is often not found.

Lap welding may be performed after battery cells are stacked; or the battery cells may be stacked after lap welding is performed for each battery cell.

### Embodiment 3

Parallel Connection and Butt Welding

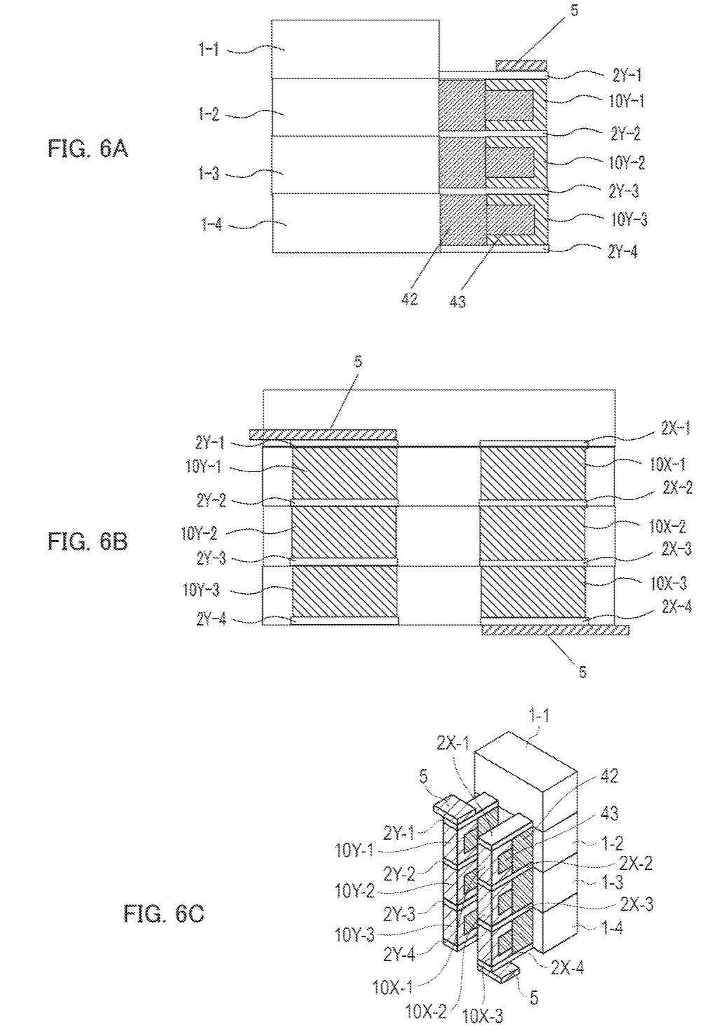

FIGS. 6A to 6C are schematic configuration views of a battery pack according to Embodiment 3. FIG. 6A is a side view of the battery pack. FIG. 6B is a front view of the battery pack, and FIG. 6C is a perspective view of the battery pack. In FIG. 6A to 6C, the same components as those in FIGS. 1A to 1C and 2 are denoted by the same reference numerals, and a description thereof will be omitted.

Battery cells 1 (1-1, 1-2, 1-3, and 1-4) in the battery pack according to Embodiment 3 are electrically connected to one another in parallel. Bus bars 10 are welded to electrode terminals 2 (positive terminals 2X or negative terminals 2Y) of stacked battery cells 1, and each bus bar 10 connects two adjacent electrode terminals 2 of the same polarity.

More specifically, as shown in FIG. 6A, bus bar 10 is U-shaped. As shown in FIG. 6B, positive terminal 2X-1 and positive terminal 2X-2 are electrically connected by bus bar 10X-1; positive terminal 2X-2 and positive terminal 2X-3, bus bar 10X-2; and positive terminal 2X-3 and positive terminal 2X-4, bus bar 10X-3. Negative terminal 2Y-1 and negative terminal 2Y-2 are electrically connected by bus bar 10Y-1; negative terminal 2Y-2 and negative terminal 2Y-3 by bus bar 10Y-2; and negative terminal 2Y-3 and negative terminal 2Y-4 by bus bar 10Y-3.

Insulating layers 42 and 43 are provided in a space between two adjacent electrode terminals 2 and a space in U-shaped bus bar 10, respectively, to ensure strength enough to withstand compression in a stacking direction and sufficient insulation.

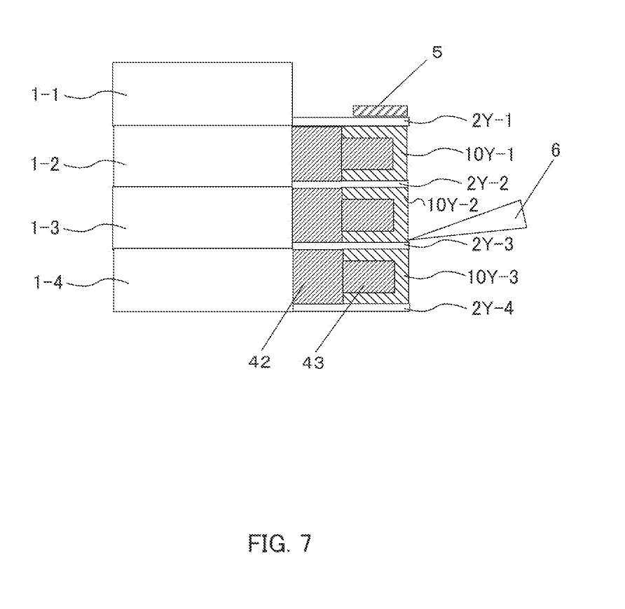

FIG. 7 is a side view of the battery pack and shows an outline of how electrode terminal 2 and bus bar 10 are butt-welded by laser. The method for laser irradiation for laser welding is the same as in Embodiment 1 (see FIG. 2. Laser beam 6 is applied to butting portions of electrode terminal 2 and bus bar 10.

Embodiments 1 and 3 illustrate a battery pack in which battery cells are connected in series by bus bars butt-welded to electrode terminals and a battery pack in which battery cells are connected in parallel, respectively. A battery pack according to the present invention may include a combination of battery cells connected in series and battery cells connected in parallel according, to characteristics required for the battery pack.

### Embodiment 4

Parallel Connection and Lap Welding

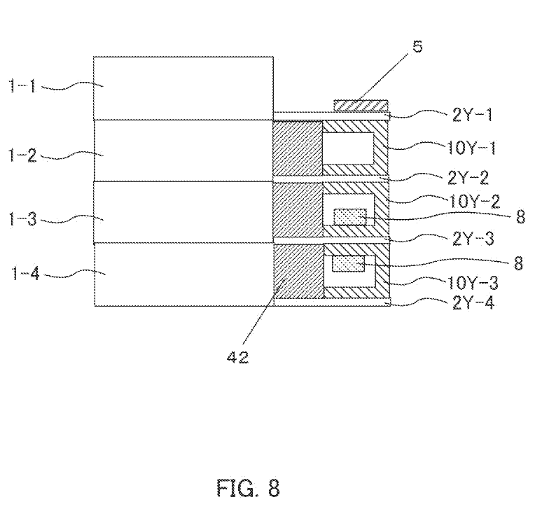

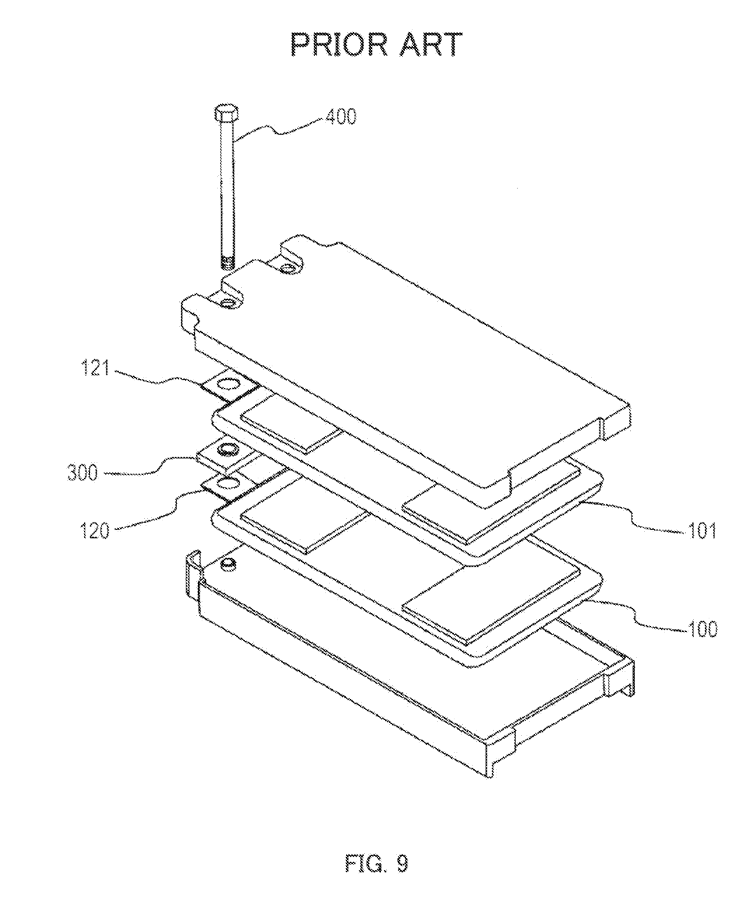

FIG. 8 is a side view of a battery pack according to Embodiment 4 and shows an outline of how electrode terminal 2 and bus bar 10 are lap-welded. In FIG. 8, the same components as those in FIG. 7 are denoted by the same reference numerals, and a description thereof will be omitted.

The battery pack according to Embodiment 4 is different from the battery pad according to Embodiment 3 (see FIG. 7) in that a space in U-shaped bus bar 10 has no insulating layer 43 and is hollow. As shown in FIG. 8, ultrasonic welding tool 8 is inserted into the space in U-shaped bus bar 10 and is energized for lap welding. After the lap welding ultrasonic welding tool 8 is removed, Insulating layer 43 may be inserted after ultrasonic welding tool 8, is removed.

Embodiments 2 and 4 illustrate a battery pack in which battery cells are connected in series by bus bars lap-welded to electrode terminals and a battery pack in Which battery cells are connected in parallel, respectively. A battery pack according to the present invention may include a combination of battery cells connected in series and battery cells connected in parallel according to characteristics required for the battery pack.

### INDUSTRIAL APPLICABILITY

The present invention provides an inexpensive battery pack that has superior output characteristics and long-term reliability. The battery pack according to the present invention is used for example in electrical storage apparatus that require high power and large capacity, including electrical products, power-assisted bicycles, electric power tools, automobiles, and home appliances.

### REFERENCE SIGNS LIST

1, 1-1, 1-2, 1-3, 1-4 Battery cell
2 Electrode terminal
2X Positive terminal
2Y Negative terminal
3, 3-1, 3-2 3-3 Bus bar
4 Insulating layer
5 General terminal
6 Laser beam
7 Welded portion
8 Ultrasonic welding tool
9 Mark
10, 10-1, 10-2, 10-3 Bus bar
42 insulating layer
43 insulating layer

1. A battery pack comprising:
a plurality of battery cells each having electrode terminals including a positive terminal and a negative terminal, the plurality of battery cells being stacked on top of one another; and
a bus bar having a bent portion, the bus bar being welded and electrically connected to the electrode terminals,
wherein each of the electrode terminals is formed of a fiat plate, and a stacking direction of the electrode terminals and a stacking direction of the plurality of battery cells are the same, and
the electrode terminal of one of the plurality of battery cells and the electrode terminal of another one of the plurality of battery cells arc electrically connected by the bus bar.

2. The battery pack according to claim 1, further comprising:
an insulator disposed between the electrode terminals of the plurality of battery cells stacked on top of one another.

3. The battery pack according to claim 1,
wherein the electrode terminals of the plurality of battery cells and the bus bar are lap-welded.

4. The pack battery according to claim 1,
wherein the electrode terminals of the plurality of battery cells and the bus bar are butt-welded.

5. The pack battery according to claim 1,
wherein the electrode terminal of one of the plurality of battery cells and the electrode terminal of another one of the plurality of battery cells, the electrode terminals being electrically connected by the bus bar, have the same polarity.

6. The pack battery according to claim 1,
wherein the electrode terminal of one of the plurality of battery cells and the electrode terminal of another one of the plurality of battery cells, the electrode terminals being electrically connected by the bus bar, have different polarities.

7. The battery pack according to claim 1,
wherein the electrode terminals protrude from respective bodies of the plurality of battery cells,
a thickness direction of the electrode terminal made of the flat plate is the same as the stacking direction of the plurality of battery cells,
an insulator is provided between a first surface of the electrode terminal of a first battery cell among the plurality of battery cells and a second surface of the electrode terminal of a second battery cell among the plurality of battery cells, the first surface being a surface perpendicular to a thickness direction of the electrode terminal of the first battery cell, the second surface being a surface perpendicular to a thickness direction of the electrode terminal of the second battery cell and facing the first surface, and
the insulator keeps a distance between the first surface and the second surface constant.
